(19) United States
(12) Patent Application Publication
(10) Pub. No.: US 2007/0022664 A1
(43) Pub. Date: Feb. 1, 2007

(54) Arrangement in a swing door apparatus provided with a door closer

(76) Inventors: Markku Mähönen, Ylamylly (FI); Markku Surakka, Joensuu (FI)

Correspondence Address: SMITH-HILL AND BEDELL, P.C., 16100 NW CORNELL ROAD, SUITE 220, BEAVERTON, OR, 97006, US

(21) Appl. No.: 10/571,376

(22) PCT Filed: Aug. 27, 2004
(86) PCT No.: PCT/FI04/00499

§ 371 Date: Mar. 10, 2006

(30) Foreign Application Priority Data
Sep. 18, 2003 (FI) 20031336

(51) Int. Cl. E05F 11/24

(52) U.S. Cl. 49/342; 49/339

(57) ABSTRACT

An arrangement in a swing door apparatus comprising a door closer provided with a return spring, which door closer comprises a body part and inside it a movable piston member, which is in force transmitting connection with a driving shaft, which is turned in accordance with the movements of the door, and an actuator, for instance an electric motor, the operating shaft of which may be in operative connection with said piston means for providing the opening movement of the door by utilizing a worm shaft, one end of which is driven by a drive nut connected to the piston member and the other end may be connected to said operating shaft of the actuator. The worm shaft comprises a worm section and a shaft section integrated thereto and provided with a flange member, which is in cooperation with a thrust bearing unit so that the moving of the worm shaft in the axial direction with respect to the body part of the door closer is prevented. Coupling means are arranged between the operating shaft of the actuator and the shaft section of the worm shaft, which coupling means are arranged to disconnect the force transmitting connection between the actuator and the shaft section of the worm shaft and to provide said force transmitting connection for accomplishing the opening movement of the door.

The invention relates to an arrangement in accordance with the preamble of claim 1.

In automatic swing door apparatuses the opening of the door is actuated by an electric motor or another suitable actuator. It is advantageous to combine a door closer with the swing door apparatus, the piston member of which door closer is driven by a driving shaft, which turns in accordance with the door motions. As the operation of the door closer is generally based on a return spring, which is compressed while the door is being opened, the closing of the door may thus even in a swing door apparatus be actuated by means of said spring without the above-mentioned actuator. In this manner the operational costs of the actuator can be cut. One problem here is the fact that the closing of the door should, especially during power failures, be accomplished at as low resistance as possible so that the closing may be ensured in all situations. If the pressure of the spring in the door closer is required for another purpose than for moving the door itself and the piston linked to the motions thereof, this may result in a need to use a more rigid spring, which affects the need of space and the costs and requires more power from the actuator which presses the spring ready for the closing of the door at the same time as the door is being opened.

For providing drive from the actuator to the driving shaft a ball-race screw arrangement or a combination of a worm shaft and a drive nut may preferably be utilized. Hereby it becomes necessary to ensure that the worm shaft is not allowed to move in the axial direction due to the door motions and/or the operation of the door closer.

As for prior art a reference is made to the publication GB 2020734 A, from which it is known per se to use a combination of a worm shaft and a drive nut for providing drive from the actuator to the driving shaft connected to the door. In general terms, the solution is complicated and takes up much space.

It is an aim of the present invention to eliminate the defects related to prior art and provide a simple and reliable solution to the above-described problems.

The aim of the present invention can be achieved in a manner described in more detail in claim 1 and in the other claims. According to the invention, the worm shaft comprises a worm section and a shaft section integrated thereto and provided with a flange member, which is in cooperation with a thrust bearing unit so that the moving of the worm shaft in the axial direction with respect to the body of the door closer is prevented. In addition, coupling means are arranged between the operating shaft of the actuator and the shaft section of the worm shaft, which coupling means are arranged to disconnect the force transmitting connection between the actuator and the shaft section of the worm shaft and to provide said force transmitting connection for accomplishing the opening movement of the door.

By the coupling means it can be ensured that the actuator and the gear possibly connected thereto are in operation only when the door is being opened, whereby in the closing phase of the door the pressure of the spring in the door closer is required only for moving the door and the piston means in force transmission relation therewith in the same way as in a conventional door closer. Similarly, by the flange member and the thrust bearing in cooperation therewith the turning of the worm shaft may be ensured in a simple manner without any moving thereof in the axial direction.

In practice, according to a preferable embodiment, one end of the drive nut is connected to the piston member and the other end is adapted to cooperate with one end of the return spring of the door closer. In this way, a solution having a simple structure is provided.

The angle of thread of the worm section of the worm shaft and the drive nut is chosen so that it is sufficiently large, for instance at least 26°, preferably about 32°-40°, so that their reciprocal cooperation is nearly reversible. As the frictional factors may thus be minimized, the spring providing the closing of the door may correspondingly be chosen so that it is less rigid. Consequently, it takes less space and requires thereby less energy from the actuator in the opening phase of the door. On the other hand there is no reason to choose an angle of thread that is too large, so that it is possible, accordingly, to have a sufficiently low torque required for turning the worm shaft, which also affects the output of the actuator.

In the following the invention is described by way of example with reference to the attached drawings, in which

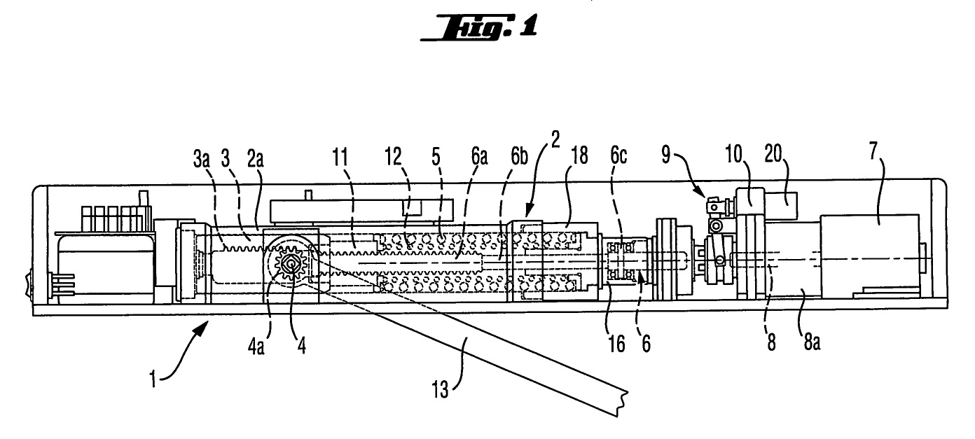

FIG. 1 is a general side view of a swing door apparatus according to the invention;

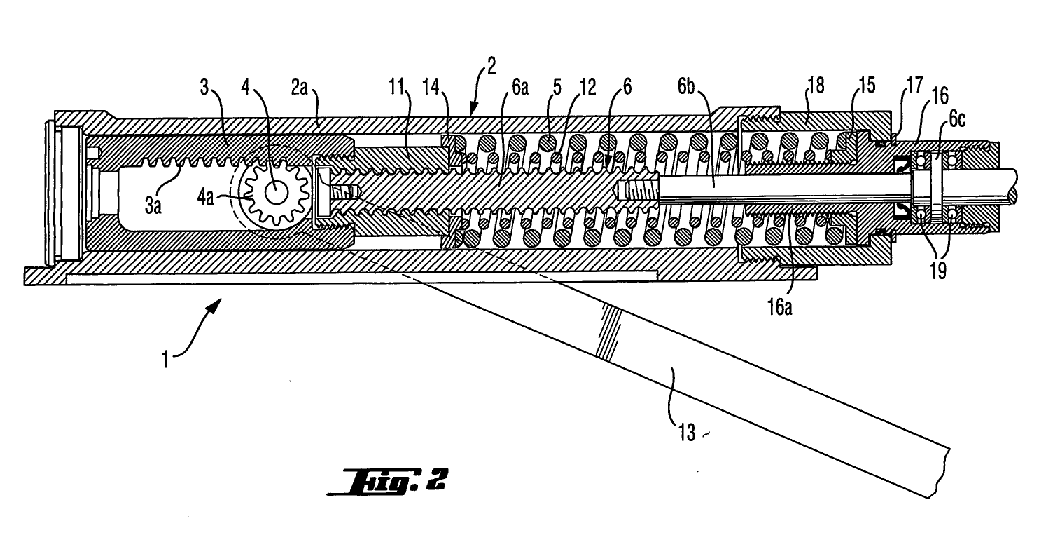

FIG. 2 shows the door closer section included in the apparatus of FIG. 1, when the door is closed; and

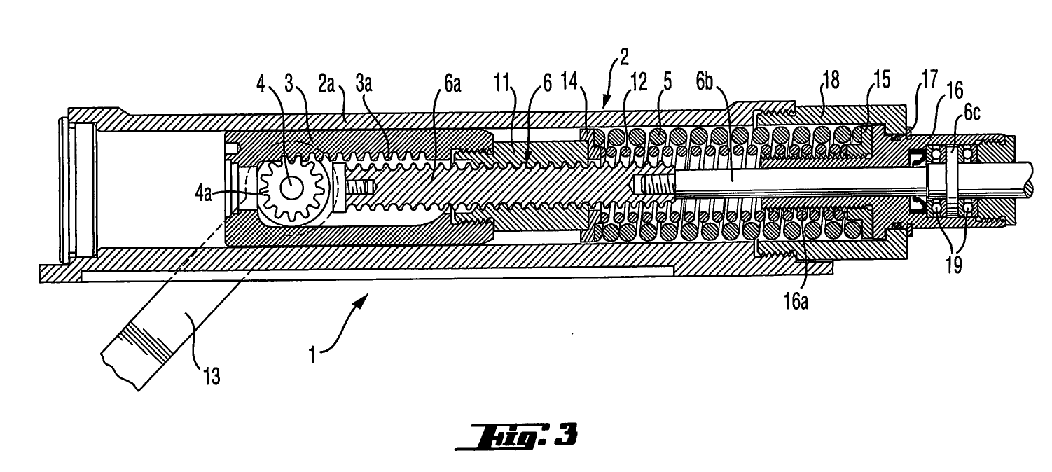

FIG. 3 shows the door closer section included in the apparatus of FIG. 1, when the door is open.

In the drawings the reference numeral 1 indicates a swing door apparatus of a door (not shown) including an electric motor 7 or another suitable actuator, by means of which the opening of the door is accomplished, and a door closer 2, which makes the door close. The door closer 2 comprises a piston means 3 driven by a driving shaft 4, which is connected to the door and turned in accordance with the door motions, a return spring 5 and a worm shaft 6, which drives the piston means 3 and provides the travel of the piston means 3 for opening the door. The operating shaft of the electric motor 7 is indicated by the reference numeral 8. A gear 8a for adapting the rotary speed of the shaft 8 to be suitable is further arranged, if needed, between the electric motor and the operating shaft 8. In addition, according to the invention, coupling means 9 provided with a body part 10, which is supported by the swing door apparatus, are arranged between the shafts 6 and 8.

The coupling means 9 may be realized in various ways and one preferable solution is disclosed in more detail in the Finnish patent application 20031180, which is referred to in this respect.

FIGS. 2 and 3 show a more detailed illustration of the construction of the door closer section in two different operating positions, respectively, i.e. when the door is closed and when it is open. The driving shaft 4 is by means of an arm 13 connected to the door not shown in the figure. On the driving shaft there is mounted a toothed gear 4a, by means of which it is connected to the gear teeth 3a on the inner surface of the piston member 3. The piston member 3 is controlled directly from the inner surface of the body part 2a of the door closer. The worm shaft 6 comprises a worm section 6a and a shaft section 6b attached thereto and provided with a flange 6c, which is in cooperation with a thrust bearing unit 19. The worm section 6a is in cooperation with a drive nut 11, which is again attached to the piston member 3. Thus the turning of the shaft 6, 6a, 6b makes the drive nut 11 and the piston member 3 move in the direction of the shaft 6. One end of the drive nut 11 supports the guide 14 of the spring 5, which guides also a second spring 1 2. The springs 5 and 12 cooperate as return springs and one end thereof is supported by a second guide 1 5.

The body part 2a supports preferably by threads an auxiliary piece 18, which supports a thrust bearing support 16, which is secured into position by a lock ring 17. The thrust bearing support 16 comprises an axial protrusion 16a, which on the other hand guides the inner spring 12 and by which the guide 15 is supported by threads. Thus, by turning the guide 15 it is possible to adjust the prestress of the springs 5 and 12.

The situation in FIG. 2 corresponds to the closed position of the door. There the springs 5 and 12 of the door closer are free from compression with the exception of their prestress provided by the guide 15. When the aim is to open the door, the actuator 7 and its shaft 8 are by the coupling means 9 connected to the shaft section 6b of the worm shaft 6 for providing drive. When the shaft 6 is turned, the threads of the worm section 6a act on the drive nut 11 and make the drive nut 11 and thereby also the piston member 3 move to the right in the figure, against the pressure of the springs 5 and 12.

The situation in FIG. 3 corresponds to the open position of the door, whereby the springs 5 and 12 are compressed. Thus the closing of the door may be simply accomplished by the normal operation of the door closer by utilizing the pressure of the springs. In order to make the energy consumption here as low as possible, whereby smaller and inexpensive springs can be chosen for the purpose, the drive of the actuator 7 is disconnected by the coupling means 9 from the shaft 6. In addition, the angle of thread of the worm section 6a and the drive nut 11 is chosen so that it is sufficiently large. In this manner the moving of the piston member 3 and thus the closing of the door may be accomplished at as low resistance as possible at the same time as the moving of the shaft 6 in the axial direction is prevented by means of the flange section 6c and the thrust bearing unit 19.

The coupling means 9 may preferably be controlled for instance by a solenoid 20. The operation of the coupling means arrangement according to the invention requires control logic and sensor arrangements for indicating the position of the door at a given time and thus for controlling the operation of the solenoid guiding the coupling means so that the swinging door apparatus can perform its automatic operation reliably. In practice, the swing door apparatus is preferably controlled so that the drive from the electric motor 7 or the like to the driving shaft 4 is switched on only when the door is being opened normally. In addition, the drive may be switched on especially in certain special situations, e.g. when the closing of the door is prevented, whereby it is necessary to run the door again to its open position, or if the pressure of the spring alone for some reason is not sufficiently high for closing the door, an auxiliary electric motor may be further utilized.

The invention is not limited to the above embodiment, but several modifications are conceivable in the scope of the appended claims.

1-3. (canceled)

4. An arrangement in a swing door apparatus comprising a door closer provided with a return spring, which door closer comprises a body part and inside it a movable piston member, which is in force transmitting connection with a driving shaft, which is turned in accordance with the movements of the door, and an actuator, for instance an electric motor, the operating shaft of which may be in operative connection with said piston means for providing the opening movement of the door by utilizing a worm shaft, one end of which is driven by a drive nut connected to the piston member and the other end may be connected to said operating shaft of the actuator, wherein the worm shaft comprises a worm section and a shaft section integrated thereto and provided with a flange member, which is in cooperation with a thrust bearing unit so that the moving of the worm shaft in the axial direction with respect to the body part of the door closer is prevented, and that coupling means are arranged between the operating shaft of the actuator and the shaft section of the worm shaft, which coupling means are arranged to disconnect the force transmitting connection between the actuator and the shaft section of the worm shaft and to provide said force transmitting connection for accomplishing the opening movement of the door.

5. An arrangement according to claim 4, wherein one end of the drive nut is connected to the piston member and the other end is arranged to cooperate with one end of the return spring of the door closer.

6. An arrangement according to claim 4, wherein the angle of thread of the worm section of the worm shaft and the drive nut is chosen so that it is sufficiently large, for instance at least 26°, preferably about 32°-40°, so that their reciprocal cooperation is nearly reversible.
